(19) United States
(12) Patent Application Publication
(10) Pub. No.: US 2026/0178905 A1
(43) Pub. Date: Jun. 25, 2026

(54) METHOD AND APPARATUS FOR IMPROVING ACCURACY OF INTEREST POINT DETECTION UNDER DIFFERENT LIGHT CONDITIONS

(71) Applicant: LG ELECTRONICS INC., Seoul (KR)

(72) Inventors: Kyle Xingkai BAO, Glenview, IL (US); Eric HWANG, Vernon Hills, IL (US); Enda MCGRATH, Park Ridge, IL (US)

(73) Assignee: LG ELECTRONICS INC., Seoul (KR)

(21) Appl. No.: 19/432,597

(22) Filed: Dec. 24, 2025

Related U.S. Application Data
(60) Provisional application No. 63/738,546, filed on Dec. 24, 2024.

(51) Int. Cl. G06N 3/08; G06V 10/77; G06V 10/82

(52) U.S. Cl. CPC G06N 3/08; G06V 10/7715; G06V 10/82

(57) ABSTRACT

According to at least one embodiment, a computer-implemented method of training a neural network for mapping an indoor environment includes: training the neural network in a first stage using a first dataset based on synthetic shapes; and training the neural network in a second stage using a second dataset based on real photographs. The method further includes, for each object of a plurality of objects, collecting a plurality of images of the object, wherein the plurality of images of the object are respectively produced under different lighting conditions; and training the neural network in a third stage using the plurality of images of the object.

### CROSS-REFERENCE TO RELATED APPLICATIONS

This application claims the benefit of earlier filing date of Provisional Application No. 63/738,546, filed on Dec. 24, 2024, the contents of which are hereby incorporated by reference herein in their entirety.

### BACKGROUND

A robot may refer to a machine that automatically processes or operates a given task by its own ability. In particular, a robot having a function of recognizing an environment and performing a self-determination operation may be referred to as an intelligent robot. Robots may be classified into various categories including industrial robots, medical robots, home robots, military robots, and the like according to the use purpose or field.

A driving unit of a robot may include an actuator or a motor and may perform various physical operations such as moving a robot joint. In addition, a movable robot may include a wheel, a brake, a propeller, and the like in a driving unit, and may travel on the ground or fly in the air.

Indoor robotic navigation is typically performed using two-dimensional (2D) or three-dimensional (3D) maps. Such maps can be used to guide robotic navigation for a variety of applications, including but not limited to autonomous vacuum cleaning, food and service delivery, tourist assistance, and automated roaming tasks.

3D maps can be generated using red-green-blue-depth (RGB-D) cameras in conjunction with simultaneous localization and mapping (SLAM) algorithms. The map data may include object identification information about various objects disposed in the space in which the robot moves. For example, the map data may include object identification information about fixed objects such as walls and doors and movable objects such as furniture and desks. The object identification information may include a name, a type, a distance, and a position of a given object. Object identification may also include its specific 2D image patterns and 3D shapes.

The robot may use at least one of the map data, object information detected by one of its sensors, or object information acquired from an external source to determine a travel route and a travel plan, and may control the driving unit such that the robot travels along the determined travel route and travel plan.

### SUMMARY

However, reliable mapping under challenging lighting (or illumination) conditions—such as low light, strong sunlight, or artificial light emitting diode (LED) lighting—poses technical difficulties in tracking camera movement and calculating camera positions and orientations. For example, reflections off of a given physical object disposed in a space in which the robot moves may vary significantly across different lighting conditions. Therefore, from the perspective of a camera sensor of the robot, the object may appear quite different across such conditions.

Aspects of this disclosure are directed to a method and apparatus for more reliably mapping indoor environments by detecting image interest points using convolutional neural network (CNN)-based deep learning models. According to at least one aspect, algorithms for camera tracking and image matching are employed, leveraging deep learning to enhance mapping and localization stability under various lighting conditions, including strong sunlight, artificial LED lighting, and low-light environments. Regarding artificial LED lighting, visible light and infrared light may be used as separate sources. For example, an infrared light source(s) and a visible LED source(s) may be turned on/off (e.g., separately) when training an interest point extractor.

According to at least one embodiment, a computer-implemented method of training a neural network for mapping an indoor environment includes: training the neural network in a first stage using a first dataset based on synthetic shapes; and training the neural network in a second stage using a second dataset based on real photographs. The method further includes, for each object of a plurality of objects, collecting a plurality of images of the object, wherein the plurality of images of the object are respectively produced under different lighting conditions; and training the neural network in a third stage using the plurality of images of the object.

According to at least one embodiment, an artificial intelligence (AI) device is configured to train a neural network for mapping an indoor environment. The AI device includes: at least one transceiver; and at least one processor. The at least one processor is configured to: train the neural network in a first stage using a first dataset based on synthetic shapes; train the neural network in a second stage using a second dataset based on real photographs; and for each object of a plurality of objects: collect a plurality of images of the object, wherein the plurality of images of the object are respectively produced under different lighting conditions; and train the neural network in a third stage using the plurality of images of the object.

According to at least one embodiment, a non-transitory storage medium stores instructions that, when executed, cause at least one processor to perform operations. The operations include: training a neural network in a first stage using a first dataset based on synthetic shapes; training the neural network in a second stage using a second dataset based on real photographs; and for each object of a plurality of objects: collecting a plurality of images of the object, wherein the plurality of images of the object are respectively produced under different lighting conditions; and training the neural network in a third stage using the plurality of images of the object.

### BRIEF DESCRIPTION OF THE DRAWINGS

The accompanying drawings, which are included to provide a further understanding of the disclosure, illustrate embodiments of the disclosure and together with the description serve to explain aspects of the disclosure:

FIG. 1 is a block diagram of an artificial intelligence (AI) device according to at least one embodiment of the present disclosure;

FIG. 2 illustrates a block diagram of an AI server according to at least one embodiment of the present disclosure;

FIG. 3 illustrates an AI system according to at least one embodiment of the present disclosure;

FIG. 4 illustrates a perspective view of a robot according to at least one embodiment;

FIG. 5 is a block diagram of a control module of a robot according to at least one embodiment;

FIG. 6 illustrates a generalized flowchart of a method of training a neural network according to at least one embodiment;

FIG. 7 illustrates joint illumination and homography training according to at least one embodiment; and

FIG. 8 illustrates a flowchart of a method of training a neural network for mapping an indoor environment according to at least one embodiment.

### DETAILED DESCRIPTION

Hereinafter, specific embodiments of the present invention will be described in more detail with reference to drawings.

When it is described that an element is “fastened” or “connected” to another element, it may mean that the two elements are directly fastened or connected, or that a third element exists between the two elements and that the two elements are fastened or connected to each other by said third element. On the other hand, when it is described that an element is “directly fastened” or “directly connected” to another element, it may be understood that no third element exists between the two elements.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

A self-driving vehicle may be regarded as a robot having a self-driving function.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The ANN may include an input layer, an output layer, and optionally one or more hidden layers. Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the ANN may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among ANNs, is also referred to as deep learning, and the deep learning is part of machine learning. In the following, machine learning is used to mean deep learning.

FIG. 1 is a block diagram of an AI device 10 according to at least one embodiment of the present disclosure. As described below, the AI device 10 may be (or may include) a robot.

The AI device 10 may be stationary or mobile. For example, the AI device may be (or may include) a TV, a projector, a mobile phone, a smartphone, a desktop computer, a notebook, a digital broadcasting terminal, a personal digital assistant (PDA), a portable multimedia player (PMP), a navigation device, a tablet personal computer (PC), a wearable device, a set-top box (STB), a DMB receiver, a radio, a washing machine, a refrigerator, a desktop computer, a digital signage, a robot, a vehicle, and the like.

The AI device 10 may include a communication interface 11, an input interface 12, a learning processor 13, a sensor 14, an output interface 15, a memory 17, and a processor 18.

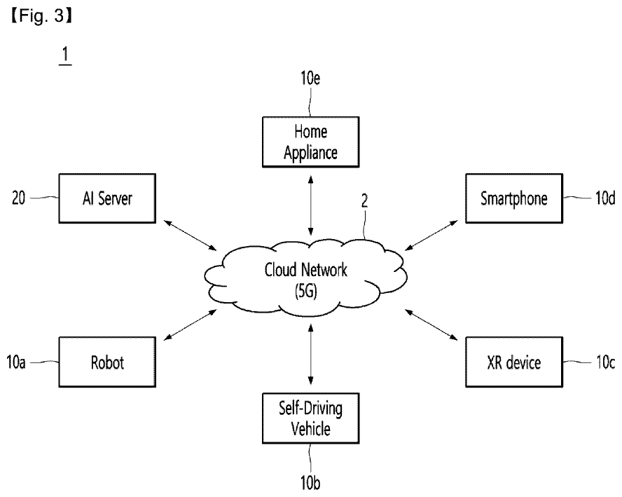

The communication interface 11 may transmit and receive data to and from external devices such as other AI devices 10a, 10b, 10c, 10d, 10e and an AI server 20 by using wired/wireless communication technology (see, e.g., FIG. 3). For example, the communication interface 11 may transmit and receive sensor information, a user input, a learning model, and a control signal to and from external devices.

The communication technology used by the communication interface 11 includes Global System for Mobile communication (GSM), Code Division Multi Access (CDMA), Long Term Evolution (LTE), 5G, Wireless LAN (WLAN), Wi-Fi, Bluetooth, Radio Frequency Identification (RFID), Infrared Data Association (IrDA), ZigBee, Near Field Communication (NFC), and the like.

The input interface 12 may acquire various kinds of data.

For example, the input interface 12 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 12 may acquire a learning data for model learning and an input data to be used when an output is acquired by using the learning model. The input interface 12 may acquire raw input data. In this case, the processor 18 or the learning processor 13 may extract an input feature by preprocessing the input data.

The learning processor 13 may learn a model composed of an ANN by using learning data. The learned ANN may be referred to as a learning model. The learning model may be used to infer a result value for new input data rather than learning data, and the inferred value may be used as a basis for determination to perform a certain operation.

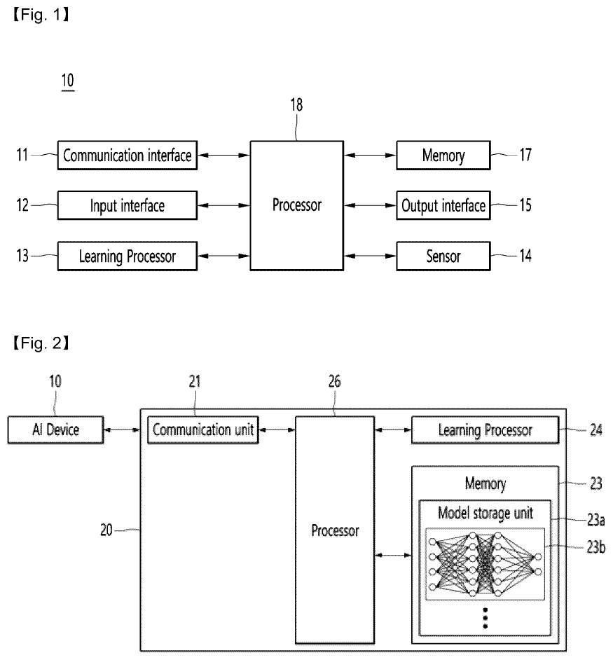

The learning processor 13 may perform AI processing together with a learning processor 24 of the AI server 20 (see, e.g., FIG. 2).

The learning processor 13 may include a memory integrated or implemented in the AI device 10. Alternatively, the learning processor 13 may be implemented by using the memory 17, an external memory directly connected to the AI device 10, or a memory held in an external device.

The sensor 14 may acquire at least one of internal information about the AI device 10, ambient environment information about the AI device 10, or user information by using various sensors.

Examples of the sensors included in the sensor 14 may include a proximity sensor, an illuminance sensor, an acceleration sensor, a magnetic sensor, a gyro sensor, an inertial sensor, a red-green-blue (RGB) sensor, an infrared (IR) sensor, a fingerprint recognition sensor, an ultrasonic sensor, an optical sensor, a microphone, a lidar, and a radar.

The output interface 15 may generate an output related to a visual sense, an auditory sense, or a haptic sense.

The output interface 15 may include a display unit for outputting time information, a speaker for outputting auditory information, and a haptic module for outputting haptic information.

The memory 17 may store data that supports various functions of the AI device 10. For example, the memory 17 may store input data acquired by the input interface 12, learning data, a learning model, a learning history, and the like.

The processor 18 may determine at least one executable operation of the AI device 10 based on information determined or generated by using a data analysis algorithm or a machine learning algorithm. The processor 18 may control components of the AI device 10 to execute the determined operation.

The processor 18 may request, search, receive, or utilize data of the learning processor 13 or the memory 17. The processor 18 may control components of the AI device 10 to execute the predicted operation or the operation determined to be desirable among the at least one executable operation.

When the connection of an external device is required to perform the determined operation, the processor 18 may generate a control signal for controlling the external device and may transmit the generated control signal to the external device.

The processor 18 may acquire intention information for the user input and may determine the user's requirements based on the acquired intention information.

The processor 18 may collect history information including the operation contents of the AI device 10 or the user's feedback on the operation and may store the collected history information in the memory 17 or the learning processor 13 or transmit the collected history information to the external device such as the AI server 20. The collected history information may be used to update the learning model.

The processor 18 may control at least part of the components of AI device 10 so as to drive an application program stored in the memory 17. Furthermore, the processor 18 may operate two or more of the components included in the AI device 10 in combination so as to drive the application program.

FIG. 2 illustrates a block diagram of an AI server 20 according to at least one embodiment of the present disclosure. As illustrated in FIG. 2, the AI server 20 is connected to the AI device 10.

The AI server 20 may refer to a device that learns an ANN by using a machine learning algorithm or uses a learned artificial neural network. The AI server 20 may include a plurality of servers to perform distributed processing, or may be defined as a 5G network. The AI server 20 may be included as a partial configuration of the AI device 10, and may perform at least part of the AI processing together.

The AI server 20 may include a communication interface 21, a memory 23, a learning processor 24, a processor 26, and the like.

The communication interface 21 can transmit and receive data to and from an external device such as the AI device 10.

The memory 23 may include a model storage unit 23a. The model storage unit 23a may store a learning or learned model (or an ANN 26b) through the learning processor 24.

The learning processor 24 may learn the ANN 26b by using the learning data. The learning model may be used in a state of being mounted on the AI server 20, or may be used in a state of being mounted on an external device such as the AI device 10.

The learning model may be implemented in hardware, software, or a combination of hardware and software. If all or part of the learning models are implemented in software, one or more instructions that constitute the learning model may be stored in memory 23.

The processor 26 may infer the result value for new input data by using the learning model and may generate a response or a control command based on the inferred result value.

FIG. 3 illustrates an AI system 1 according to at least one embodiment of the present disclosure

In the AI system 1, at least one of an AI server 20, a robot 10a, a self-driving vehicle 10b, an XR device 10c, a smartphone 10d, or a home appliance 10e is connected to a cloud network 2. The robot 10a, the self-driving vehicle 10b, the XR device 10c, the smartphone 10d, or the home appliance 10e, to which the AI technology is applied, may be referred to as AI devices 10a to 10e, collectively.

The cloud network 2 may refer to a network that forms part of a cloud computing infrastructure or exists in a cloud computing infrastructure. The cloud network 2 may be configured by using a 3G network, a 4G or LTE network, or a 5G network.

That is, the devices 10a to 10e and the server 20 configuring the AI system 1 may be connected to each other through the cloud network 2. In particular, each of the devices 10a to 10e and the server 20 may communicate with each other through a base station, but may directly communicate with each other without using a base station.

The AI server 20 may include a server that performs AI processing and a server that performs operations on big data.

The AI server 20 may be connected to at least one of the AI devices constituting the AI system 1, that is, the robot 10a, the self-driving vehicle 10b, the XR device 10c, the smartphone 10d, or the home appliance 10e through the cloud network 2, and may assist at least part of AI processing of the connected AI devices 10a to 10e.

For example, the AI server 20 may learn the ANN according to the machine learning algorithm instead of the AI devices 10a to 10e, and may directly store the learning model or transmit the learning model to the AI devices 10a to 10e.

The AI server 20 may receive input data from the AI devices 10a to 10e, may infer the result value for the received input data by using the learning model, may generate a response or a control command based on the inferred result value, and may transmit the response or the control command to the AI devices 10a to 10e.

Alternatively, the AI devices 10a to 10e may infer the result value for the input data by directly using the learning model, and may generate the response or the control command based on the inference result.

Hereinafter, various embodiments of the AI devices 10a to 10e to which the above-described technology is applied will be described in more detail. The AI devices 10a to 10e of FIG. 3 may be regarded as specific embodiments of the AI device 10 of FIG. 1.

The robot 10a, to which the AI technology is applied, may be implemented as a guide robot, a carrying robot, a cleaning robot, a wearable robot, an entertainment robot, a pet robot, an unmanned flying robot, or the like.

The robot 10a may include a robot control module for controlling the operation, and the robot control module may refer to a software module or a chip implementing the software module by hardware.

The robot 10a may acquire state information about the robot 10a by using sensor information acquired from various kinds of sensors, may detect (recognize) surrounding environment and objects, may generate map data, may determine the route and the travel plan, may determine the response to user interaction, or may determine the operation.

The robot 10a may use the sensor information acquired from at least one sensor among the lidar, the radar, and the camera so as to determine the travel route and the travel plan.

The robot 10a may perform the above-described operations by using the learning model composed of at least one ANN. For example, the robot 10a may recognize the surrounding environment and the objects by using the learning model, and may determine the operation by using the recognized surrounding information or object information. The learning model may be learned directly from the robot 10a or may be learned from an external device such as the AI server 20.

The robot 10a may perform the operation by generating the result by directly using the learning model, but the sensor information may be transmitted to the external device such as the AI server 20 and the generated result may be received to perform the operation.

The robot 10a may use at least one of the map data, the object information detected from the sensor information, or the object information acquired from the external apparatus to determine the travel route and the travel plan, and may control the driving unit such that the robot 10a travels along the determined travel route and travel plan.

In addition, the robot 10a may perform the operation or travel by controlling the driving unit based on the control/interaction of the user. The robot 10a may acquire the intention information of the interaction due to the user's operation or speech utterance, and may determine the response based on the acquired intention information, and may perform the operation.

The robot 10a, to which the AI technology and the self-driving technology are applied, may be implemented as a guide robot, a carrying robot, a cleaning robot, a wearable robot, an entertainment robot, a pet robot, an unmanned flying robot, or the like.

The robot 10a, to which the AI technology and the self-driving technology are applied, may refer to the robot itself having the self-driving function or the robot 10a interacting with the self-driving vehicle 10b.

The robot 10a having the self-driving function may collectively refer to a device that moves for itself along the given movement line without the user's control or moves for itself by determining the movement line by itself.

The robot 10a may be a guide robot that provides various information to users at airports, subways, bus terminals, or the like, a serving robot that can serve various items to guests at restaurants, hotels, or the like, a delivery robot that can transport items such as food, medicine, and delivery items (hereinafter referred to as “items”), or an industrial robot that transports a cart loaded with parts to a destination at a factory, or the like.

According to various embodiments, a robot includes devices that are used for specific purposes (cleaning, ensuring security, monitoring, guiding and the like) or that moves to offer functions according to features of a space in which the robot is moving. Accordingly, devices that have transportation means capable of moving using predetermined information and sensors, and that offer predetermined functions are generally referred to as a robot.

A robot may move with a map stored in it. The map denotes information on fixed objects such as fixed walls, fixed stairs and the like that do not move in a space. Additionally, information on movable obstacles that are disposed periodically, i.e., information on dynamic objects may be stored on the map.

As an example, information on obstacles disposed within a certain range with respect to a direction in which the robot moves forward may also be stored in the map. In this case, unlike the map in which the above-described fixed objects are stored, the map includes information on obstacles, which is registered temporarily, and then removes the information after the robot moves

Further, the robot may confirm an external dynamic object using various sensors. When the robot moves to a destination in an environment that is crowded with a large number of pedestrians after confirming the external dynamic object, the robot may confirm a state in which waypoints to the destination are occupied by obstacles.

Furthermore, the robot may determine that it arrives at a waypoint on the basis of a degree in a change of directions of the waypoint. The robot then moves to the next waypoint, and, accordingly, the robot can move to a destination successfully.

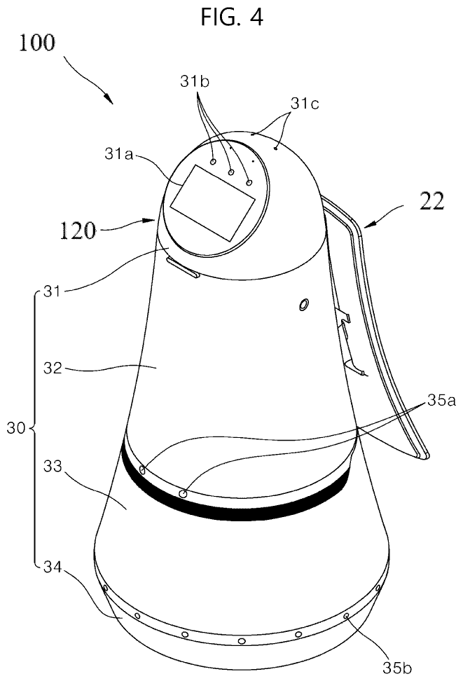

FIG. 4 illustrates a perspective view of a robot 100 according to at least one embodiment. FIG. 4 shows an exemplary appearance. It is understood that the robot may be implemented as robots having various appearances in addition to the appearance of FIG. 4. Specifically, each component may be disposed in different positions in the upward, downward, leftward and rightward directions on the basis of the shape of a robot.

A main body 120 may be configured to be long in the up-down direction, and may have the shape of a roly poly toy that gradually becomes slimmer from the lower portion toward the upper portion, as a whole.

The main body 120 may include a case 30 that forms the appearance of the robot 100. The case 30 may include a top cover 31 disposed on the upper side, a first middle cover 32 disposed on the lower side of the top cover 31, a second middle cover 33 disposed on the lower side of the first middle cover 32, and a bottom cover 34 disposed on the lower side of the second middle cover 33. The first middle cover 32 and the second middle cover 33 may constitute a single middle cover.

The top cover 31 may be disposed at the uppermost end of the robot 100, and may have the shape of a hemisphere or a dome. The top cover 31 may be disposed at a height below the average height for adults to readily receive an instruction from a user. Additionally, the top cover 31 may be configured to rotate at a predetermined angle.

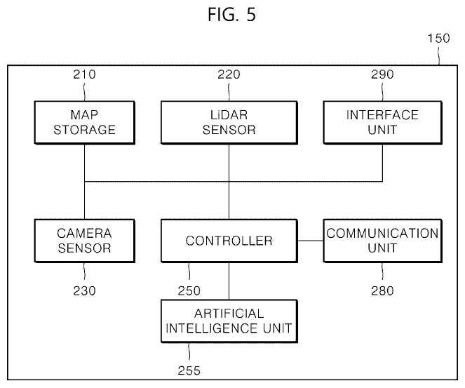

The robot 100 may further include a control module 150 therein (see, e.g., FIG. 5). The control module 150 controls the robot 100 like a type of computer or a type of processor. Accordingly, the control module 150 may be disposed in the robot 100, may perform functions similar to those of a main processor, and may interact with a user.

The control module 150 is disposed in the robot 100 to control the robot during the robot's movement by sensing objects around the robot. The control module 150 of the robot may be implemented as a software module, a chip in which a software module is implemented as hardware, and the like.

A display unit 31a that receives an instruction from a user or that outputs information, and sensors, for example, a camera 31b and a microphone 31c may be disposed on one side of the front surface of the top cover 31.

In addition to the display unit 31a of the top cover 31, a display unit 22 is also disposed on one side of the middle cover 32.

Information may be output by all the two display units 31a, 22 or may be output by any one of the two display units 31a, 22 according to functions of the robot.

Additionally, various obstacle sensors (e.g., sensor 220 of FIG. 5) are disposed on one lateral surface or in the entire lower end portion of the robot 100 like 35a, 35b. As an example, the obstacle sensors include a time-of-flight (TOF) sensor, an ultrasonic sensor, an infrared sensor, a depth sensor, a laser sensor, a LiDAR sensor and the like. The sensors sense an obstacle outside of the robot 100 in various ways.

Additionally, the robot 100 further includes a moving unit that is a component moving the robot in the lower end portion of the robot. The moving unit is a component that moves the robot, like wheels.

The shape of the robot in FIG. 4 is provided as an example. Embodiments of the present disclosure are not limited to the illustrated example. Additionally, various cameras and sensors of the robot may also be disposed in various portions of the robot 100. As an example, the robot 100 may be a guide robot that gives information to a user and moves to a specific spot to guide a user.

The robot 100 may also include a robot that offers cleaning services, security services or functions. The robot 100 may perform a variety of functions.

In a state in which a plurality of robots 100 are disposed in a service space, the robots may perform specific functions (guide services, cleaning services, security services and the like). In such a process, the robot 100 may store information on its position, may confirm its current position in the entire space, and may generate a path required for moving to a destination.

FIG. 5 is a block diagram of a control module 150 of the robot 100 according to at least one embodiment.

The robot 100 may perform both of the functions of generating a map and estimating a position of the robot using the map.

Alternately, the robot 100 may only offer the function of generating a map.

Alternately, the robot 100 may only offer the function of estimating a position of the robot using the map. According to various embodiments, the robot 100 offers the function of estimating a position of the robot using the map. Additionally, the robot 100 may offer the function of generating a map or modifying a map.

A LiDAR sensor 220 may sense surrounding objects two-dimensionally or three-dimensionally. A two-dimensional LiDAR sensor may sense positions of objects within 360-degree ranges with respect to the robot 100. LiDAR information sensed in a specific position may constitute a single LiDAR frame. That is, the LiDAR sensor 220 senses a distance between an object disposed outside the robot 100 and the robot to generate a LiDAR frame.

As an example, a camera sensor 230 is a regular camera. To overcome viewing angle limitations, two or more camera sensors 230 may be used. An image captured in a specific position constitutes vision information. That is, the camera sensor 230 photographs an object outside the robot 100 and generates a visual frame including vision information.

According to various embodiment, the robot 100 performs fusion-simultaneous localization and mapping (Fusion-SLAM) using the LiDAR sensor 220 and the camera sensor 230.

In fusion SLAM, LiDAR information and vision information may be combinedly used. The LiDAR information and vision information may be configured as maps.

Unlike a robot that uses a single sensor (LiDAR-only SLAM, visual-only SLAM), a robot that uses fusion-SLAM may enhance accuracy of estimating a position. That is, when fusion SLAM is performed by combining the LiDAR information and vision information, map quality may be enhanced.

The map quality is a criterion applied to both of the vision map comprised of pieces of vision information, and the LiDAR map comprised of pieces of LiDAR information. At the time of fusion SLAM, map quality of each of the vision map and LiDAR map is enhanced because sensors may share information that is not sufficiently acquired by each of the sensors.

Additionally, LiDAR information or vision information may be extracted from a single map and may be used. For example, LiDAR information or vision information, or all the LiDAR information and vision information may be used for localization of the robot in accordance with an amount of memory held by the robot 100 or a calculation capability of a calculation processor, and the like.

An interface unit 290 receives information input by a user. The interface unit 290 receives various pieces of information such as a touch, a voice and the like input by the user, and outputs results of the input. Additionally, the interface unit 290 may output a map stored by the robot 100 or may output a course in which the robot 100 moves by overlapping on the map.

Further, the interface unit 290 may supply predetermined information to a user.

A controller 250 generates a map, and, on the basis of the map, estimates a position of the robot 100 in the process in which the robot moves.

A communication unit 280 may allow the robot 100 to communicate with another robot or an external server and to receive and transmit information.

The robot 100 may generate each map using each of the sensors (a LiDAR sensor and a camera sensor), or may generate a single map using each of the sensors and then may generate another map in which details corresponding to a specific sensor are only extracted from the single map.

Additionally, the map may include odometry information on the basis of rotations of wheels. The odometry information is information on distances moved by the robot 100, which are calculated using frequencies of rotations of a wheel of the robot, or a difference in frequencies of rotations of both wheels of the robot, and the like. The robot 100 may calculate a distance moved by the robot on the basis of the odometry information as well as the information generated using the sensors.

The controller 250 may further include an artificial intelligence unit 255 for artificial intelligence work and processing.

A plurality of LiDAR sensors 220 and camera sensors 230 may be disposed outside of the robot 100 to identify external objects.

In addition to the LiDAR sensor 220 and camera sensor 230, various types of sensors (a LiDAR sensor, an infrared sensor, an ultrasonic sensor, a depth sensor, an image sensor, a microphone, and the like) are disposed outside of the robot 100. The controller 250 collects and processes information sensed by the sensors.

The artificial intelligence unit 255 may input information that is processed by the LiDAR sensor 220, the camera sensor 230 and the other sensors, or information that is accumulated and stored while the robot 100 is moving, and the like, and may output results required for the controller 250 to determine an external situation, to process information and to generate a moving path.

As an example, the robot 100 may store information on positions of various objects, disposed in a space in which the robot is moving, as a map. The objects may include a fixed object such as a wall, a door and the like, and a movable object such as a flower pot, a desk and the like. The artificial intelligence unit 255 may output data on a path taken by the robot 100, a range of work covered by the robot, and the like, using map information and information supplied by the LiDAR sensor 220, the camera sensor 230 and the other sensors.

Additionally, the artificial intelligence unit 255 may recognize objects disposed around the robot 100 using information supplied by the LiDAR sensor 220, the camera sensor 230 and the other sensors. The artificial intelligence unit 255 may output meta information on an image by receiving the image. The meta information includes information on the name of an object in an image, a distance between an object and the robot, the sort of an object, whether an object is disposed on a map, and the like.

Information supplied by the LiDAR sensor 220, the camera sensor 230 and the other sensors is input to an input node of a deep learning network of the artificial intelligence unit 255, and then results are output from an output node of the artificial intelligence unit 255 through information processing of a hidden layer of the deep learning network of the artificial intelligence unit 255.

The controller 250 may calculate a moving path of the robot using date calculated by the artificial intelligence unit 255 or using data processed by various sensors.

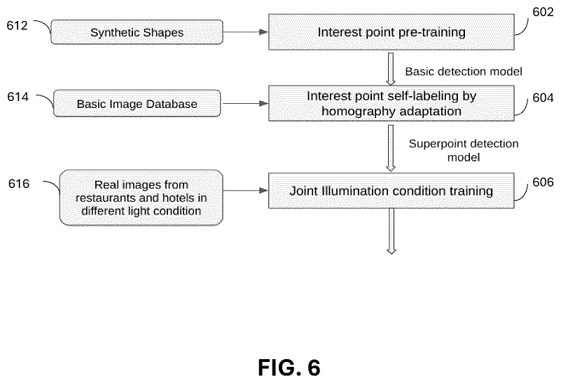

FIG. 6 illustrates a generalized flowchart of a method of training a neural network according to at least one embodiment. The neural network may include a model for detecting interest points in an image. Interest points are 2D locations in an image which are stable and repeatable from different lighting conditions and viewpoints. The neural network may be trained using convolutional deep learning. With reference to FIG. 6, the method will be described with reference to three stages.

At a first stage 602 (e.g., interest point pre-training phase), the neural network is trained to generate pseudo-ground truth interest point labels for unlabeled images. Here, the training may occur in a self-supervised fashion. For this training, a dataset 612 including (or based on) synthetic shapes is used as input. Examples of such synthetic shapes may include a triangle, a rectangle, and a cross or check. Using a dataset 612 that is based on such simple shapes (rather than full-size images) increases speed of training at this first stage 602. The training produces a basic detection model that is to be further trained at a second stage 604.

At the second stage 604 (e.g., interest point self-labeling phase), interest point detection accuracy is improved by performing training using full size images. The training is performed using a dataset 614 that uses (or is based on) real photos. By way of example, the dataset 614 may include photographs of building exteriors, pieces of room furniture, windows, toys, street views, plants, animals, and human pedestrians. The dataset 614 is larger than the dataset 612 used at the first stage 602.

Here, different images of the dataset 614 may be taken from different angles of views and/or at different distances. To account for this aspect, the detection model (e.g., the basic detection model output by the first stage 602) is trained using a technique called homography, by which a same image is permuted by random cropping, translation, scaling, image rotation, and/or perspective distortion methods. The training based on such permuted images produces a superpoint detection model that is to be further trained at a third stage 606.

At the third stage 606 (e.g., joint illumination condition training), the accuracy of interest point detection is further improved. Here, joint illumination condition deep learning training is used, and the increase in accuracy may be significant. The training at the third stage 606 is performed using a dataset 616 that uses (or is based on) images taken at particular settings such as restaurants or hotels.

In experiments conducted in settings such as commercial environment and buildings (e.g., restaurants, hotels and airports), it was found that different illumination conditions have a critical impact on detection robustness and accuracy. This may arise because reflections from a surface of a given physical object may vary significantly across different lighting conditions. Therefore, from the perspective of a camera sensor (e.g., camera sensor 230 of FIG. 5), the object may appear quite different across such conditions. By way of example, under ambient light, it may be possible to extract the feature points of the object perfectly. However, for the same object, the accuracy of interest point detection may suffer under lighting conditions different from the ambient light condition—e.g., artificial LED light condition, low light conditions, etc.

Aspects of the present disclosure are directed to improving the accuracy of interest point detection in such different lighting conditions. For example, in at least one aspect, training is performed to account for multiple light conditions (or joint light conditions). In at least further aspect, the training is performed together with homography deep learning. Regarding the artificial LED light condition, visible light and infrared light may be considered as separate sources. For example, an infrared light source(s) and a visible LED source(s) may be turned on/off (e.g., separately) when training an interest point extractor.

In typical indoor environments, illumination conditions can be controlled by toggling or controlling artificial lighting and/or adjusting window treatments to control a level of natural sunlight. A training dataset (e.g., dataset 616) is created by collecting photo images taken at different settings (e.g., at different rooms or areas of a commercial setting) under varying illumination conditions. This dataset is more comprehensive than the datasets 612, 614 used at the first and second stages 602, 604. This enhances the robustness of the interest point detection model that is produced.

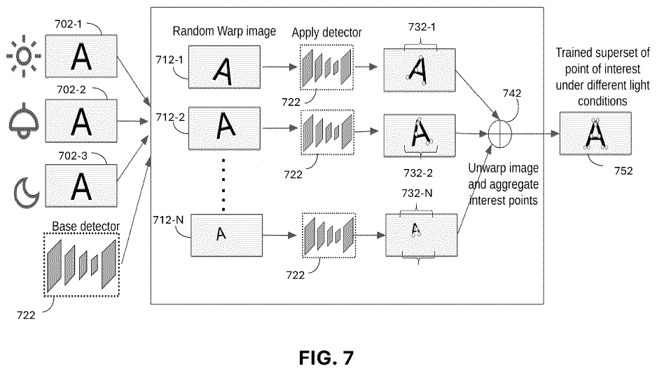

Features of joint illumination and homography training according to at least one embodiment will now be described in more detail with reference to FIG. 7.

For purposes of simplicity, the features and/or processes will be described below with reference to different images of a same object (e.g., a refrigerator). However, it is understood that for the disclosed features and/or processes may similarly apply to each of a plurality of objects—e.g., objects that would be encountered by a robot such as robot 100 of FIG. 4 while moving in a commercial setting.

With reference to FIG. 7, a training dataset includes a plurality of images of a same object. The images of the object are produced under different lighting conditions. For example, the images include an image 702-1 of the object produced under a bright-natural-light lighting condition (e.g., strong sunlight), an image 702-2 of the object produced under an artificial-light lighting condition (e.g., LED light), and an image 702-3 of the object produced under a low-natural-light lighting condition (e.g., darklight). The upper-case letter ‘A’ is used to represent the object in FIG. 7.

As noted earlier regarding the artificial LED lighting condition, visible light and infrared light may be used (e.g., separately) as sources of the artificial LED light. For example, an infrared light source(s) and a visible LED source(s) may be turned on/off (e.g., separately) when training an interest point extractor. Compared to visible LED light, infrared light has a longer wavelength and is invisible to the human eye. Infrared light may be particularly useful in dark environments or when tracking objects with reflective glass or metallic surfaces.

The different lighting conditions may correspond to different illuminations levels in units of lux. For example, the bright-natural-light lighting condition of the image 702-1 may correspond to an illumination in a range of 10,000 to 25,000 lux. The artificial-light lighting condition of the image 702-2 may correspond to an illumination in a range of 50 to 1000 lux. The low-natural-light lighting condition of the image 702-3 may correspond to an illumination in a range of 3.4 to 40 lux. As noted above, infrared light may be used as a source of artificial LED light. Infrared light is not measured in lux, as lux is a unit specific to visible light, reflecting human eye perception. Instead, infrared light is quantified with reference to irradiance, typically expressed in milliwatts per square centimeter (mW/cm²). According to various embodiments, by adjusting the distance between the object and the infrared LED source, the irradiance level can be varied, by way of example, from 0.1 to 10 mW/cm².

For the object, a collective set (e.g., superset 752) of pseudo-ground truth interest point locations is produced as a result of training.

The superset 752 of interest point locations are based on interest point locations generated for image 702-1, interest point locations generated for image 702-2 and interest point locations generated for image 702-3.

For purposes of simplicity, the disclosure below will describe the generation of the interest point locations for image 702-1, and the contribution of such interest point locations towards the superset 752. However, it is understood that interest point locations for images 702-2 and 702-3 may be generated in a similar manner, and that such interest point locations contribute in a similar manner towards the superset 752.

As will be described in more detail below, random homographic transformations are separately applied to a same input image to produce warped copies of the input image. Each warped image is input to an trained neural network model, which extracts a corresponding set of interest points from the warped image. Finally, interest points extracted from correspondingly unwarped images are combined to contribute towards a superset, which constitutes the output.

With continued reference to FIG. 7, random homographic transformations are separately applied to the image 702-1 to produce N warped copies of the input image. By way of example, the value of N may be 100. In this situation, 100 random homographic transformations are separately applied to the image 702-1 to produce 100 warped copies of the input image.

Each warped copy may be considered as a different permutation of the image 702-1. For example, the warped copies may include a permutation of the image 702-1 by cropping, a permutation of the image 702-1 by translation, a permutation of the image 702-1 by scaling, a permutation of the image 702-1 by rotation and/or a permutation of the image 702-1 by a combination of two or more of such distortions.

FIG. 7 illustrates examples 712-1, 712-2 and 712-N of warped copies of the image 702-1. The example 712-1 corresponds to a rotation (clockwise rotation) of the image 702-1 at a first angle that is also tilted. The example 712-2 corresponds to a rotation (counter-clockwise rotation) of the image 702-1 at a second angle that is also tilted. The example 712-N is a scaled-down (size-reduced) rotation of the image 702-1 at a third angle that is also tilted.

With continued reference to FIG. 7, each of the warped copies is input to a base detector 722. According to at least one embodiment, the base detector is the superpoint detection model described earlier with reference to FIG. 6. As described earlier with reference to FIG. 6, the superpoint detection model is produced by the second stage of training.

However, it is understood that the base detector may be a different model. For example, the base detector may be the basic detection model described earlier with reference to FIG. 6. As described earlier with reference to FIG. 6, the basic detection model is produced by the first stage of training.

Returning to FIG. 7, each of the warped copies is input to the base detector 722. For example, the example 712-1 is input to the base detector 722. In response, the base detector 722 outputs a set of interest point locations 732-1 based on the example 712-1. Each interest point location in the set 732-1 is illustrated in FIG. 7 as a shaded circle.

Here, the manner by which the image 702-1 was randomized to produce the example 712-1 is known. As such, it is possible to perform inverse processing such that the example 712-1 is un-warped. Concurrently, this inverse processing will also un-warp the set of interest point locations 732-1 as well. The un-warped set of interest point locations 732-1 are input to the aggregator 742 so that multiple sets of interest point locations can be aggregated.

Here, the multiple sets of interest point locations include an un-warped set of interest point locations 732-2 (corresponding to the example 712-2) and an un-warped set of interest point locations 732-N (corresponding to the example 712-N).

The generation of the interest point locations for image 702-1 and the contribution of such interest point locations towards the superset 752 have been described. As noted earlier, it is understood that interest point locations for images produced under different lighting conditions (e.g., 702-2 and 702-3) may be generated in a similar manner, and that such interest point locations contribute in a similar manner towards the superset 752.

For example, if the value of N is 100, then 100 random homographic transformations are separately applied to the image 702-2 to produce 100 warped copies of the input image. Similarly, 100 random homographic transformations are separately applied to the image 702-3 to produce 100 warped copies of the input image. Similar to the manner described earlier with reference to examples 712-1, 712-2 and 712-N, each of the warped copies is input to the base detector 722.

Accordingly, 300 sets of interest point locations are combined to produce the superset 752 of interest point locations that covers the same object as it appears under different light conditions.

The joint training illustrated in FIG. 7 is described mathematically below.

Let ƒ_{θ}(·) represent the initial interest point function that is to be adapted, I represent the input image, x represent the resulting interest points, and H denote a random homography. The relationship between x and ƒ_{θ}(·) is expressed as follows:

x=ƒ_{θ}(I)

An ideal interest point operator should be covariant with respect to homographies. A function ƒ_{θ}(I) is covariant with H if the output transforms with the input. In other words, a covariant detector will satisfy for all:

$${H}_{x} = {f}_{θ} ( H ( I ) )$$

The variable i may be used as an index with respect to image illumination condition (or illumination group), and the variable j may be used as an index with respect to random homographic distortion. As such

$$x = {H}_{j}^{- 1} {f}_{θ} ( {H}_{j} ( {I}_{i} ) ) .$$

According to at least one aspect of this disclosure, an empirical sum over a sufficiently large sample of random homographic distortions is performed for each light condition. The resulting aggregation over samples thus gives rise to a new and improved, interest point detector, F\hat{ }(I; ƒ_{θ}):

$$F \hat{} ( I ; {f}_{θ} ) = \frac{1}{{N}_{l} {N}_{h}} {\sum }_{i = 1}^{{N}_{l}} {\sum }_{j = 1}^{{N}_{h}} {H}_{j}^{- 1} {f}_{θ} ( {H}_{j} ( {I}_{i} ) ) ,$$

where Nₗ denotes the number of illumination groups and Nₕ denotes the number of random homographic distortions. According to at least one embodiment, the maximum number of illumination groups ranges from 2 to 4. For example, with reference to FIG. 7, 3 different illumination groups were described. However, it is understood that the maximum number of illumination groups may be larger.

According to at least one embodiment, the maximum number of random homographic distortions is 100. However, it is understood that the maximum number of homographic distortions may be larger.

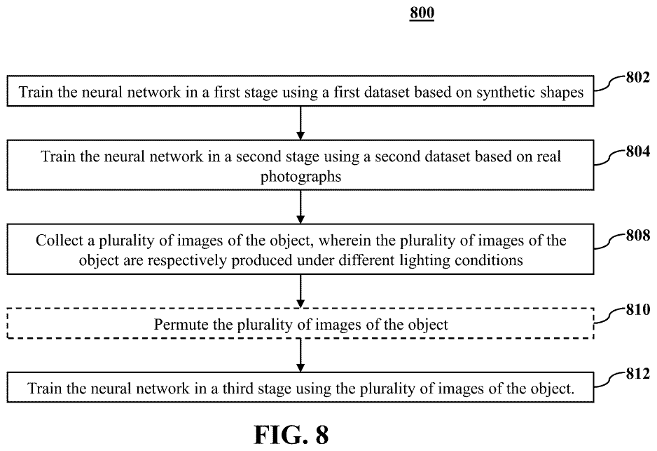

FIG. 8 illustrates a flowchart of a method 800 of training a neural network for mapping an indoor environment according to at least one embodiment.

At block 802, the neural network is trained in a first stage using a first dataset based on synthetic shapes.

For example, as described earlier with reference to FIG. 6, at a first stage 602, the neural network is trained to generate pseudo-ground truth interest point labels for unlabeled images. A dataset 612 including (or based on) synthetic shapes is used as input.

At block 804, the neural network is trained in a second stage using a second dataset based on real photographs.

For example, as described earlier with reference to FIG. 6, at the second stage 604, interest point detection accuracy is improved by performing training using full size images. The training is performed using a dataset 614 that uses (or is based on) real photos.

At block 806, for a given object of a plurality of objects, a plurality of images of the object are collected. Here, the plurality of images of the object are respectively produced under different lighting conditions. The different lighting conditions under which the plurality of images are respectively produced may include lighting conditions other than an ambient lighting condition.

For example, the lighting conditions other than the ambient lighting condition may include at least one of: a bright-natural-light lighting condition; a low-natural-light lighting condition; or an artificial-light lighting condition. As another example, the lighting conditions other than the ambient lighting condition may include: a bright-natural-light lighting condition; a low-natural-light lighting condition; and an artificial-light lighting condition.

According to a further embodiment, the bright-natural-light lighting condition corresponds to an illumination in a range of 10,000 to 25,000 lux, a low-natural-light lighting condition corresponds to an illumination in a range of 3.4 to 40 lux, and an artificial-light lighting condition corresponds to an illumination in a range of 50 to 1000 lux.

According to a further embodiment, for each object of the plurality of objects, the plurality of images of the object include: a first image of the object produced under the bright-natural-light lighting condition; a second image of the object produced under the low-natural-light lighting condition; and a third image of the object produced under the artificial-light lighting condition.

For example, as described earlier with reference to FIG. 7, collected images include an image 702-1 of the object produced under a bright-natural-light lighting condition (e.g., strong sunlight), an image 702-2 of the object produced under an artificial-light lighting condition (e.g., LED light), and an image 702-3 of the object produced under a low-natural-light lighting condition (e.g., dark light).

At block 810, the plurality of images of the object may be permuted. For example, the plurality of images of the object may be permuted based on random homography transformation.

According to a further embodiment, the permuted plurality of images of the object includes: a first image of the object as permuted by cropping; a second image of the object as permuted by translation; a third image of the object as permuted by scaling; and a fourth image of the object as permuted by image rotation.

For example, as described earlier with reference to FIG. 7, examples 712-1, 712-2 and 712-N of warped copies of the image 702-1 are illustrated. The example 712-1 corresponds to a rotation (clockwise rotation) of the image 702-1 at a first angle that is also tilted. The example 712-2 corresponds to a rotation (counter-clockwise rotation) of the image 702-1 at a second angle that is also tilted. The example 712-N is a scaled-down (size-reduced) rotation of the image 702-1 at a third angle that is also tilted.

At block 812, the neural network is trained in a third stage using the plurality of images of the object. Training the neural network in the third stage may include training the neural network using the first image of the object, the second image of the object, and the third image of the object. For example, training the neural network in the third stage may include training the neural network using the permuted plurality of images of the object.

For example, as described earlier with reference to FIG. 7, each of the warped copies is input to the base detector 722. By way of example, the example 712-1 is input to the base detector 722. In response, the base detector 722 outputs a set of interest point locations 732-1 based on the example 712-1.

According to a further embodiment, for each object of the plurality of objects, the training of the neural network in the third stage is for training the neural network to output a superset of interest points, where each subset of the superset corresponds to a respective lighting condition of the different lighting conditions.

For example, as described earlier with reference to FIG. 7, interest point locations are generated for image 702-1, such interest point locations contribute towards the superset 752. Also, interest point locations for images produced under different lighting conditions (e.g., 702-2 and 702-3) are generated in a similar manner, and such interest point locations contribute in a similar manner towards the superset 752.

Here, it is understood that blocks 808, 810 and 812 may be performed for each of multiple objects.

Aspects and features described herein with reference to various embodiments are directed towards generating maps of indoor environments to support autonomous robot navigation. Such aspects and features may enhance the quality, reliability, and efficiency of map generation. Resulting maps can be used to guide robotic navigation for a variety of applications, including but not limited to autonomous vacuum cleaning, food and service delivery, tourist assistance, and automated roaming tasks.

The above-described embodiments are combinations of the components and features of the disclosure in specific forms. Each component or feature should be considered optional unless explicitly mentioned otherwise. Each component or feature may be implemented without being combined with other elements or features. Furthermore, some components and/or features may be combined to implement embodiments of the disclosure. The order of operations described in the embodiments of the disclosure may be rearranged. Some components or features of one embodiment may be included in another embodiment, or the components or features may be replaced with related components or features of the other embodiment. It is obvious that claims that are not explicitly cited in the appended claims may be combined to form an embodiment or included as a new claim by amendment after filing.

It is evident to those skilled in the art that the disclosure could be realized in various specific forms within the scope of the features of the disclosure. Therefore, the detailed description above should not be interpreted restrictively in all respects but should be considered as illustrative. The scope of the disclosure should be determined by a reasonable interpretation of the appended claims, and all changes within the equivalent scope of the disclosure are encompassed within the scope of the disclosure.

What is claimed is:

1. A computer-implemented method of training a neural network for mapping an indoor environment, the computer-implemented method comprising:
training the neural network in a first stage using a first dataset based on synthetic shapes;
training the neural network in a second stage using a second dataset based on real photographs; and
for each object of a plurality of objects:
collecting a plurality of images of the object,
wherein the plurality of images of the object are respectively produced under different lighting conditions; and
training the neural network in a third stage using the plurality of images of the object.

2. The computer-implemented method of claim 1, wherein the different lighting conditions under which the plurality of images are respectively produced include lighting conditions other than an ambient lighting condition.

3. The computer-implemented method of claim 2, wherein the lighting conditions other than the ambient lighting condition include at least one of:
a bright-natural-light lighting condition;
a low-natural-light lighting condition; or
an artificial-light lighting condition.

4. The computer-implemented method of claim 2, wherein the lighting conditions other than the ambient lighting condition include:
a bright-natural-light lighting condition;
a low-natural-light lighting condition; and
an artificial-light lighting condition.

5. The computer-implemented method of claim 4, wherein the artificial-light lighting condition is provided using at least one or more infrared light sources or one or more visible light emitting diode (LED) sources.

6. The computer-implemented method of claim 4, wherein:
the bright-natural-light lighting condition corresponds to an illumination in a range of 10,000 to 25,000 lux;
a low-natural-light lighting condition corresponds to an illumination in a range of 3.4 to 40 lux; and
an artificial-light lighting condition corresponds to an illumination in a range of 50 to 1000 lux.

7. The computer-implemented method of claim 4, wherein, for each object of the plurality of objects:
the plurality of images of the object comprise:
a first image of the object produced under the bright-natural-light lighting condition;
a second image of the object produced under the low-natural-light lighting condition; and
a third image of the object produced under the artificial-light lighting condition; and
training the neural network in the third stage comprises training the neural network using the first image of the object, the second image of the object, and the third image of the object.

8. The computer-implemented method of claim 1, further comprising:
for each object of the plurality of objects:
permuting the plurality of images of the object,
wherein training the neural network in the third stage comprises training the neural network using the permuted plurality of images of the object.

9. The computer-implemented method of claim 8, wherein the plurality of images of the object are permuted based on random homography transformation.

10. The computer-implemented method of claim 9, wherein the permuted plurality of images of the object comprises:
a first image of the object as permuted by cropping;
a second image of the object as permuted by translation;
a third image of the object as permuted by scaling; and
a fourth image of the object as permuted by image rotation.

11. The computer-implemented method of claim 1, wherein, for each object of the plurality of objects:
the training of the neural network in the third stage is for training the neural network to output a superset of interest points, wherein each subset of the superset corresponds to a respective lighting condition of the different lighting conditions.

12. An artificial intelligence (AI) device configured to train a neural network for mapping an indoor environment, the AI device comprising:
at least one transceiver; and
at least one processor configured to:
train the neural network in a first stage using a first dataset based on synthetic shapes;
train the neural network in a second stage using a second dataset based on real photographs; and
for each object of a plurality of objects:
collect a plurality of images of the object,
wherein the plurality of images of the object are respectively produced under different lighting conditions; and
train the neural network in a third stage using the plurality of images of the object.

13. The AI device of claim 12, wherein the different lighting conditions under which the plurality of images are respectively produced include lighting conditions other than an ambient lighting condition.

14. The AI device of claim 13, wherein the lighting conditions other than the ambient lighting condition include:
a bright-natural-light lighting condition;
a low-natural-light lighting condition; and
an artificial-light lighting condition.

15. The AI device of claim 14, wherein:
the bright-natural-light lighting condition corresponds to an illumination in a range of 10,000 to 25,000 lux;
a low-natural-light lighting condition corresponds to an illumination in a range of 3.4 to 40 lux; and
an artificial-light lighting condition corresponds to an illumination in a range of 50 to 1000 lux.

16. The AI device of claim 14, wherein, for each object of the plurality of objects:
the plurality of images of the object comprise:
a first image of the object produced under the bright-natural-light lighting condition;
a second image of the object produced under the low-natural-light lighting condition; and
a third image of the object produced under the artificial-light lighting condition; and
the at least one processor is further configured to train the neural network in the third stage by training the neural network using the first image of the object, the second image of the object, and the third image of the object.

17. The AI device of claim 12, further comprising:
for each object of the plurality of objects:
permuting the plurality of images of the object,
wherein training the neural network in the third stage comprises training the neural network using the permuted plurality of images of the object.

18. The AI device of claim 17, wherein the plurality of images of the object are permuted based on random homography transformation.

19. The AI device of claim 12, wherein, for each object of the plurality of objects:
the training of the neural network in the third stage is for training the neural network to output a superset of interest points, wherein each subset of the superset corresponds to a respective lighting condition of the different lighting conditions.

20. A non-transitory storage medium storing instructions that, when executed, cause at least one processor to perform operations, the operations comprising
training a neural network in a first stage using a first dataset based on synthetic shapes;
training the neural network in a second stage using a second dataset based on real photographs; and
for each object of a plurality of objects:
collecting a plurality of images of the object,
wherein the plurality of images of the object are respectively produced under different lighting conditions; and
training the neural network in a third stage using the plurality of images of the object.
